(19) United States
(12) Patent Application Publication
(10) Pub. No.: US 2003/0182212 A1
(43) Pub. Date: Sep. 25, 2003

(54) Methods and systems for managing business information

(76) Inventors: Daniel Patrick Moscone, Norwalk, CT (US); John Chiang Chang, Stamford, CT (US); Colleen Patricia Harkness, Greenwich, CT (US); Joseph William Turza, Wilton, CT (US); Brian Peter Ward, Wilton, CT (US)

Correspondence Address: John S. Beulick, Armstrong Teasdale LLP, Suite 2600, One Metropolitan Sq., St. Louis, MO, 63102, US

(21) Appl. No.: 10/105,105

(22) Filed: Mar. 22, 2002

(51) Int. Cl. G06F 17/60

(52) U.S. Cl. 705/30

(57) ABSTRACT

A method for managing business information by a first business entity using a server system is provided. The server system is coupled to a centralized database and at least one client system. The method includes receiving at the server system business information relating to at least one second business entity through the client system, calculating business information based on the business information previously entered through the client system, generating a plurality of reports based on the business information, validating the business information contained in the reports, and storing the business information and the generated reports in the centralized database.

### BACKGROUND OF THE INVENTION

This invention relates generally to managing business information and, more particularly, to network-based methods and systems for calculating, validating, and managing business information.

Businesses engaging in complex deals, such as commercial financing, mergers, and acquisitions, generally conduct a credit analysis to validate the assets and liabilities of the party involved in the deal. The credit analysis facilitates the financing business to better evaluate and manage the risk associated with the deal. These businesses typically continue to analyze the parties involved in these deals even after the deal is entered into so as to monitor the financial condition of the parties.

During a credit analysis, business information is gathered from many sources. The business information is often complex and relates to various relevant areas of the overall transaction. At least some of the business information is dynamic. Therefore, a number of different members of a credit team, also known as a deal team, may need to have access to the same business information in evaluating the deal and in continuing to monitor the parties after the deal has been finalized. Moreover, the internal deal teams may need to summarize the business information from a plurality of sources, calculate new business information from information already acquired, validate the business information, and maintain the business information as it changes over time.

Internal deal teams typically manually and individually collect data as part of a credit analysis. The efforts are often duplicated, and as such, the same data may be entered multiple times on multiple different systems throughout the financing business. Individual collection of business information by various internal deal teams increases the risk of overlapping data collection and decreases time efficiency. Further, individual reporting by deal team members increases the risk of providing inconsistent or incomplete data during the documentation process, which may result in increased cycle time and costs. Moreover, because business information may change over time, deal teams must be able to maintain historical business information for future evaluation.

### BRIEF DESCRIPTION OF THE INVENTION

In one aspect, a method for managing business information by a first business entity using a server system is provided. The server system is coupled to a centralized database and at least one client system. The method includes receiving at the server system business information relating to at least one second business entity through the client system, calculating business information based on the business information previously entered through the client system, generating a plurality of reports based on the business information, validating the business information contained in the reports, and storing the business information and the generated reports in the centralized database.

In another aspect, a method for managing business information by a first business entity using a server system is provided. The server system is coupled to a centralized database, at least one managerial user system, and at least one client system. The method includes receiving at the server system business information relating to at least one second business entity through the client system, calculating business information based on business information previously entered through the client system, generating a plurality of reports based on the business information, validating the business information contained in the reports, storing the business information and the plurality of reports generated therefrom in the centralized database, updating the centralized database periodically with newly received business information and a newly generated plurality of reports, tracking the business information and reports stored in the centralized database, receiving a request for at least one of business information and reports through the client system, providing the requested business information and reports in response to the request, and providing a report to at least one managerial user system relating to a review by a user of the business information and the plurality of reports generated therefrom.

In another aspect, a network based system for managing business information by a first business entity is provided. The system includes a client system comprising a browser, a centralized database for storing information, and a server system configured to be coupled to the client system and the database. The server system is further configured to receive business information relating to at least one second business entity from the client system, calculate business information based on business information previously entered through the client system, generate a plurality of reports based on business information, validate the business information contained in the reports, store the business information and the plurality of reports generated therefrom in the centralized database, update the centralized database periodically with newly received business information and a newly generated plurality of reports, track business information and reports stored in the centralized database, receive a request for at least one of business information and reports through the client system, and provide the requested business information and reports in response to the request.

In another aspect, a computer program embodied on a computer readable medium for managing business information by a first business entity is provided. The program includes a code segment that receives business information relating to at least one second business entity and then calculates business information based on business information previously received, generates a plurality of reports based on business information received, validates business information contained in the reports, stores business information and the generated reports in a database, updates the database by adding, editing, and revising business information, tracks business information stored in the database, and provides users with access to business information.

### BRIEF DESCRIPTION OF THE DRAWINGS

FIG. 1 is a simplified block diagram of one embodiment of a Business Information Coordination System (BICS).

FIG. 2 is an expanded version block diagram of an example embodiment of a server architecture of the BICS.

FIG. 3 shows a configuration of a database within the database server of the server system including other related server components.

FIG. 4 is a flowchart illustrating a process for calculating and validating business information by a BICS.

FIG. 5 is an example embodiment of a user interface displaying a login page of a BICS.

FIG. 6 is an example embodiment of a user interface displaying an income statement page for calculating business information on a BICS.

FIG. 7 is an exemplary embodiment of a user interface displaying a balance sheet page for validating business information on a BICS.

FIG. 8 is an exemplary embodiment of a user interface displaying a collateral metrics and financial ratio page for calculating business information on a BICS.

FIG. 9 is an example embodiment of an entity relationship diagram for a BICS.

FIG. 10 is a listing of data tables and key fields used by a BICS.

FIG. 11 is an alternative listing of additional example data tables and key fields used by a BICS.

FIG. 12 is an alternative listing of additional example data tables and key fields used by a BICS.

FIG. 13 is an alternative listing of additional example data tables and key fields used by a BICS.

FIG. 14 is an alternative listing of additional example data tables and key fields used by a BICS.

FIG. 15 is an alternative listing of additional example data tables and key fields used by a BICS.

FIG. 16 is an alternative listing of additional example data tables and key fields used by a BICS.

FIG. 17 is an alternative listing of additional example data tables and key fields used by a BICS.

FIG. 18 is an alternative listing of additional example data tables and key fields used by a BICS.

FIG. 19 is an alternative listing of additional example data tables and key fields used by a BICS.

FIG. 20 is an alternative listing of additional example data tables and key fields used by a BICS.

FIG. 21 is an alternative listing of additional example data tables and key fields used by a BICS.

FIG. 22 is an alternative listing of additional example data tables and key fields used by a BICS.

### DETAILED DESCRIPTION OF THE INVENTION

Exemplary embodiments of systems and processes that facilitate integrated network-based electronic reporting and workflow process management related to a Business Information Coordination System (BICS) are described below in detail. The systems and processes facilitate, for example, electronic submission of information using a client system, automated extraction of information, and web-based reporting for internal system users. The BICS facilitates a business engaging in complex deals, such as commercial financing, mergers, and acquisitions, to collect, manage, store, and disseminate business information among internal deal teams to facilitate a more accurate and efficient exchange of information. The BICS also enables a user to collect, manage, store, and disseminate business information relating to a plurality of deals.

In one embodiment, the BICS collects, tracks, displays, and disseminates real time business information, which is defined as information relating to a first business entity being analyzed (“Analyzed Business”) by a second business engaging in complex deals, such as commercial financing, mergers, and acquisitions (“Structured Finance Business” or “SF Business”). Business information includes at least one of an industry, a segment, a company name, a deal, operating metrics, cash flow statements, covenant compliance, financial statements, capital structure, income statements, leverage, collateral, guarantors, liquidation value, and other documents and information relating to the financial condition of the Analyzed Business.

The BICS enables the SF Business to input business information relating to an Analyzed Business during a single occasion and into a single computer workstation that may be located at various locations. In addition, the BICS permits the various internal deal team members within the SF Business to share business information relating to the Analyzed Business. The BICS also enables a user to summarize business information from a plurality of sources, calculate other business information based on the previously entered business information, and validate the business information to confirm that it was accurately entered and correct. The BICS also enables the user to maintain and evaluate previously received business information, and compare it to newly received business information. Thus, the BICS permits the SF Business to devote more time to analyzing the business information, and less time entering, checking and reporting data. In an alternative embodiment, the BICS enables internal deal team members to provide business information to authorized outside users for review and analysis.

Business information relating to Analyzed Business is received by the BICS which stores the business information in a database, updates the database with business information, maintains each revision to the business information, tracks the business information received, calculates other business information based on the previously entered business information, validates the business information, provides business information in response to an inquiry, and allows selected internal deal team members to review and comment on the business information.

In the BICS, business information is stored in the database. The network based BICS provides convenient access to business information, including at least one of an industry, a segment, a company name, a deal, operating metrics, cash flow statements, availability analysis, covenant compliance, coverage ratios, financial statements, capital structure, income statements, leverage, collateral, guarantors, liquidation value, equity valuation, and other documents and information relating to the financial condition of the Analyzed Business. In one embodiment, users are authorized to gain access into the BICS, and once the BICS home page is accessed, the user will be able to choose from a list of industries, business segments, companies and deals that relate to a specific Analyzed Business and for which the user has been granted access. Once the user selects the company and the deal to be reviewed, the user can review business information relating to the Analyzed Business associated with the selected deal. In an example embodiment, only an authorized user can access the business information. In addition, the example embodiment enables a user to maintain, utilize, and view previous revisions to the business information for the Analyzed Business and the selected deal.

In one embodiment, the system is a computer program embodied on a computer readable medium implemented utilizing a Structured Query Language (SQL) with a client user interface front-end for administration and a web interface for standard user input and reports. In an example embodiment, the system is web enabled and is operated on a business-entity's intranet. The system operates in a Windows® NT environment (Windows is a registered trademark of Microsoft Corporation, Redmond, Wash.). In an alternative embodiment, the system is web enabled and is operated via the Internet.

The systems and processes are not limited to the specific embodiments described herein. In addition, components of each system and each process can be practiced independent and separate from other components and processes described herein. Each component and process also can be used in combination with other assembly packages and processes.

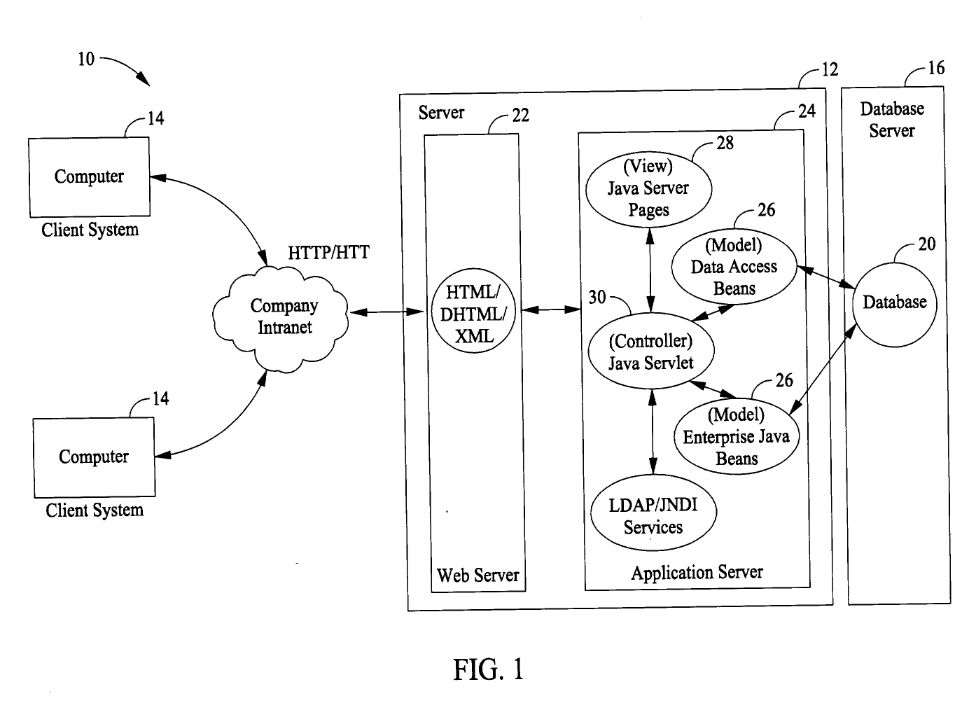

FIG. 1 is a simplified block diagram of a Business Information Coordination System (BICS) 10 including a server system 12, and a plurality of client sub-systems, also referred to as client systems 14, connected to server system 12. In one embodiment, client systems 14 are computers including a web browser, such that server system 12 is accessible to client systems 14 via an intranet. Client systems 14 are interconnected through many interfaces including a network, such as a local area network (LAN) or a wide area network (WAN). In an alternative embodiment, client systems 14 are computers including a web browser, such that server system 12 is accessible to client systems 14 via the Internet, and client systems 14 are interconnected to the Internet through dial-in-connections, cable modems and special high-speed ISDN lines. In the alternative embodiment, client systems 14 could be any device capable of interconnecting to the Internet including a web-based phone, personal digital assistant (PDA), or other web-based connectable equipment.

A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized. In the example embodiment, database 20 is an Oracle® database that contains tables and procedures defined to access the business information (Oracle is a registered trademark of Oracle Corporation, Redwood City, Calif.).

Client system 14 includes a browser. Server system 12 includes a Web Server 22 and an Application Server 24. In the example embodiment, Application Server 24 includes at least one of a model component 26, a view component 28, and a controller component 30. Model component 26 is a data and business-logic component that is responsible for executing the business logic for BICS 10. Model component 26 may serve various views, for example, in the example embodiment, model component 26 may be implemented by utilizing Enterprise Java® Beans and Data Access Beans (Java is a registered trademark of Sun Microsystems, Inc., Mountain View, Calif.). View component 28 is a presentation component of BICS 10, which is also known as the user-interface component. View component 28 may also serve many views providing different presentations of a single model. View component 28 may be implemented using Java® Server Pages. More specifically, controller component 30 is a component that responds to the user input. Controller component 30 translates user-interface events into changes to the model, and then defines the way the user-interface reacts to those events. In the example embodiment, controller component 30 may be implemented using Java® Servlets (Java is a registered trademark of Sun Microsystems, Inc., Mountain View, Calif.).

In the example embodiment, BICS 10 will support a plurality of known browsers. The screens for BICS 10 may be in the form of static HTML pages. The HTML pages may be loaded directly from the web server, or may be dynamically generated by Java® Server Pages on the web application server and sent to the browser.

Accordingly, in the example embodiment, BICS 10 performs the business logic and presentation logic separately. As explained below in greater detail, when a request is received by BICS 10, the request is directed to the controller Servlet. The controller Servlet, on the basis of the request, will invoke the corresponding Enterprise Java® Bean, which contains the business logic and fetches data from the database using Java® helper classes. The corresponding Java® Server Page is then selected and displayed to the user on client system 14. The controller Servlet also ensures that security is uniformly applied, the application state is initialized, and important workflow is not bypassed.

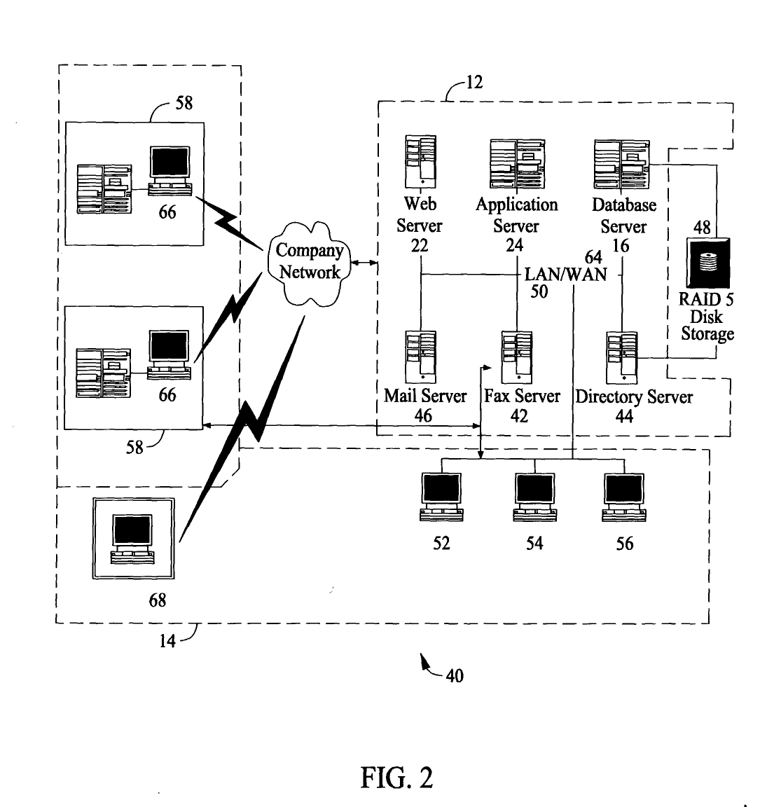

FIG. 2 is an expanded version block diagram of an exemplary embodiment of a server architecture of a BICS 40. Components in system 40, identical to components of system 10 (shown in FIG. 1), are identified in FIG. 2 using the same reference numerals as used in FIG. 1. System 40 includes server system 12 and client systems 14. Server system 12 further includes database server 16, application server 24, web server 22, a fax server 42, a directory server 44, and a mail server 46. A disk storage unit 48 is coupled to database server 16 and directory server 44. Servers 16, 22, 24, 42, 44, and 46 are coupled in a local area network (LAN) 50. In addition, a system administrator's workstation 52, a user workstation 54, and a supervisor's workstation 56 are coupled to LAN 50. Alternatively, workstations 52, 54, and 56 are coupled to LAN 50 through an intranet.

Each workstation, 52, 54, and 56 is a personal computer having a web browser. Although the functions performed at the workstations typically are illustrated as being performed at respective workstations 52, 54, and 56, such functions can be performed at one of many personal computers coupled to LAN 50. Workstations 52, 54, and 56 are illustrated as being associated with separate functions only to facilitate an understanding of the different types of functions that can be performed by individuals having access to LAN 50. In an exemplary embodiment, client system 14 includes workstation 54 which can be used by an internal deal team user to review business information relating to an Analyzed Business.

Server system 12 is configured to be communicatively coupled to various individuals, including employees 58. The communication in the exemplary embodiment is illustrated as being performed via an intranet, however, any other wide area network (WAN) type communication can be utilized in other embodiments, i.e., the systems and processes are not limited to being practiced via an intranet. In addition, and rather than WAN 64, local area network 50 could be used in place of WAN 64.

In the example embodiment, any authorized individual having a workstation 66 can access BICS 40. At least one of the client systems includes a manager workstation 68 located at a remote location but connected through an intranet. Workstations 66 and 68 are personal computers having a web browser. Also, workstations 66 and 68 are configured to communicate with server system 12. Furthermore, fax server 42 communicates with remotely located client systems, including a client system 68 via a telephone link. Fax server 42 is configured to communicate with other client systems 52, 54, and 56 as well.

In an alternative embodiment, manager workstation 68 is connected to BICS 10 through the Internet and may be utilized by an authorized outside user.

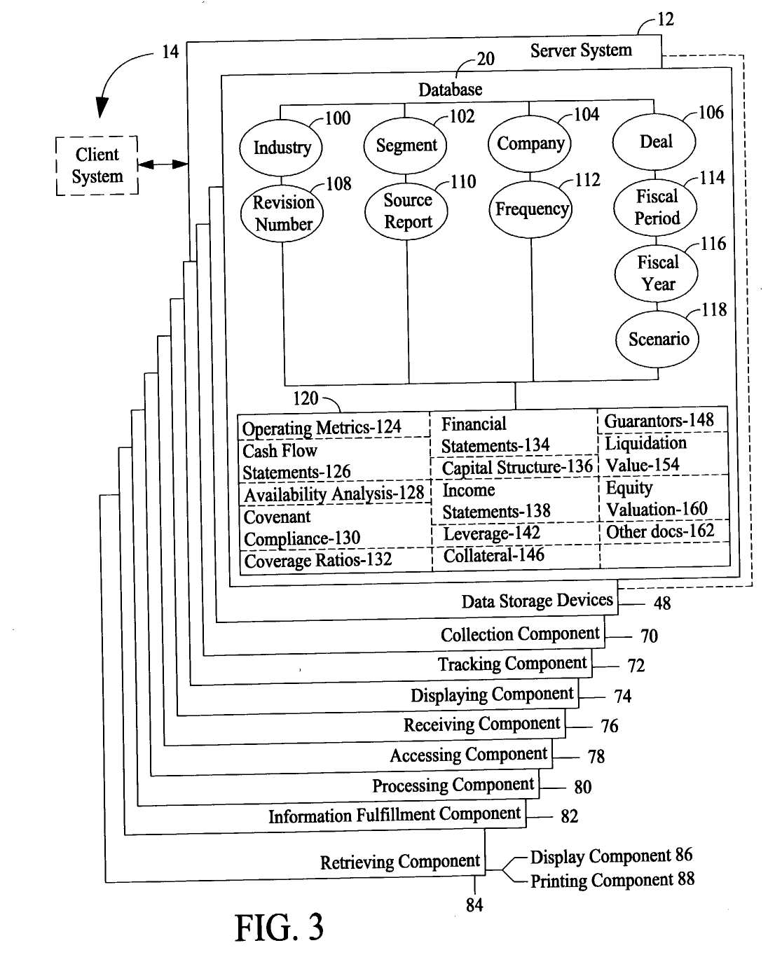

FIG. 3 shows a configuration of database 20 within database server 16 of server system 12 shown in FIG. 1. Database 20 is coupled to a plurality of separate computer software components within server system 12, which perform specific tasks. In the example embodiment, server system 12 includes a collection component 70 for collecting data from users in database 20, a tracking component 72 for tracking data, and a displaying component 74 to display information. Tracking component 72 tracks and cross-references data, including modifying existing data.

Server system 12 also includes a receiving component 76 to receive a specific query from client system 14, and an accessing component 78 to access database 20 within data storage device 48. Receiving component 76 is programmed to receive a query from one of a plurality of users. Server system 12 further includes a processing component 80 for searching and processing received queries against database 20 containing a variety of information collected by collection component 70. Processing component 80 also performs calculation and validation functions on business information entered into server system 12. An information fulfillment component 82 located in server system 12 enables the requested information to be downloaded to the plurality of users in response to the requests received by receiving component 76. Information fulfillment component 82 downloads the information after the information is retrieved from database 20 by a retrieving component 84. Retrieving component 84 retrieves, downloads and sends information to client system 14 based on a query received from client system 14.

Retrieving component 84 also includes a display component 86 that is configured to download information to be displayed on a client system's graphical user interface, and a printing component 88 that is configured to print information. Retrieving component 84 generates reports requested by the user through client system 14 in a pre-determined format.

In one embodiment, collection component 70, tracking component 72, displaying component 74, receiving component 76, accessing component 78, processing component 80, information fulfillment component 82, retrieving component 84, display component 86, and printing component 88 are computer programs embodied on computer readable medium.

Database 20 is divided into an Industry Section 100, a Segment Section 102, a Company Section 104, a Deal Section 106, a Revision No. Section 108, a Source Report Section 110, a Frequency Section 112, a Fiscal Period Section 114, a Fiscal Year Section 116, and Scenario Section 118. Database 20 also stores business information 120 relating to at least one Analyzed Business, which includes at least one of the following: operating metrics 124, cash flow statements 126, availability analysis 128, covenant compliance 130, coverage ratios 132, financial statements 134, a capital structure 136, income statements 138, leverage 142, collateral 146, guarantors 148, a liquidation value 154, an equity valuation 160, and other documents and information 162 relating to the financial condition of the Analyzed Business.

Industry Section 100 contains a plurality of industries that may relate to an Analyzed Business within BICS 10 (shown in FIG. 1), and Segment Section 102 contains a plurality of business segments that may relate to an Analyzed Business within BICS 10. Company Section 104 contains the name of each Analyzed Business that has a report generated and stored within BICS 10. Deal Section 106 contains the names of each specific deal involving each Analyzed Business that has been entered into BICS 10. Revision No. 108 contains each revision to each report generated by BICS 10 for each Analyzed Business entered into BICS 10.

Source Report 110 contains a source of business information 120 for each report entered into BICS 10. Frequency 112 contains a period of time, e.g., monthly, quarterly, or year-to-date, that business information 120 covers for each Analyzed Business entered into BICS 10. Fiscal Period 114 contains each month that business information 120 covers for each Analyzed Business entered into BICS 10. Fiscal Year 116 contains the year that business information 120 relates to for each Analyzed Business entered into BICS 10. Scenario 118 contains the scenarios, e.g., Actual, CR Base Case, Budget, and Projection, for each report generated within BICS 10.

System 10 accumulates a variety of confidential data and has different access levels to control and monitor the security of and access to system 10. Authorization for access is assigned by system administrators on a need to know basis. In one embodiment, access is provided based on job functions. In yet another embodiment, system 10 provides access based on business-entity. The administration/editing capabilities within system 10 are also restricted to ensure that only authorized individuals have access to modify or edit the data existing in the system. System 10 manages and controls access to system data and information.

The architectures of system 10 as well as various components of system 10 are exemplary only. Other architectures are possible and can be utilized in connection with practicing the processes described below.

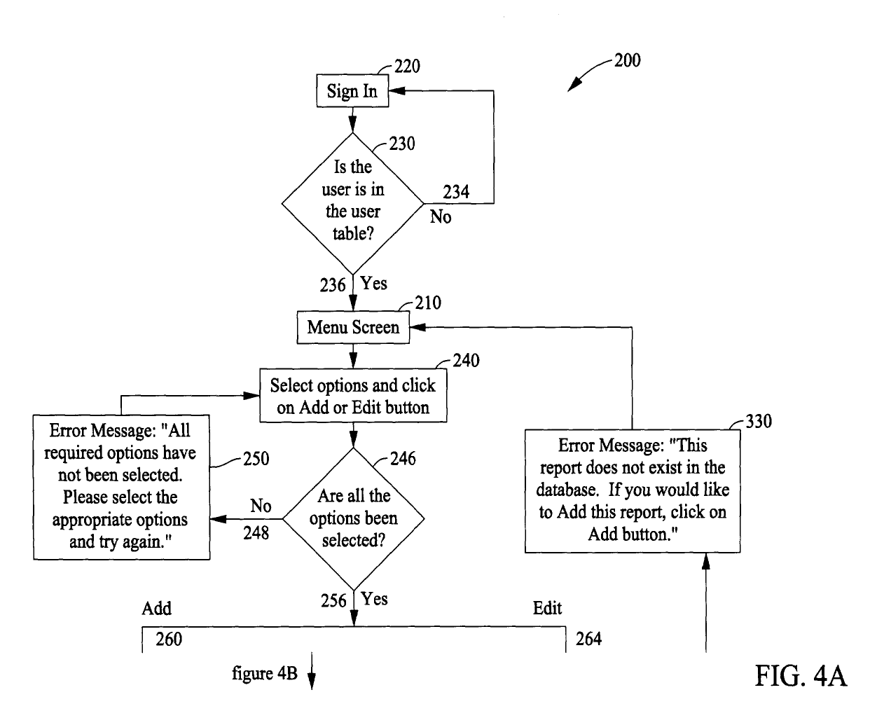

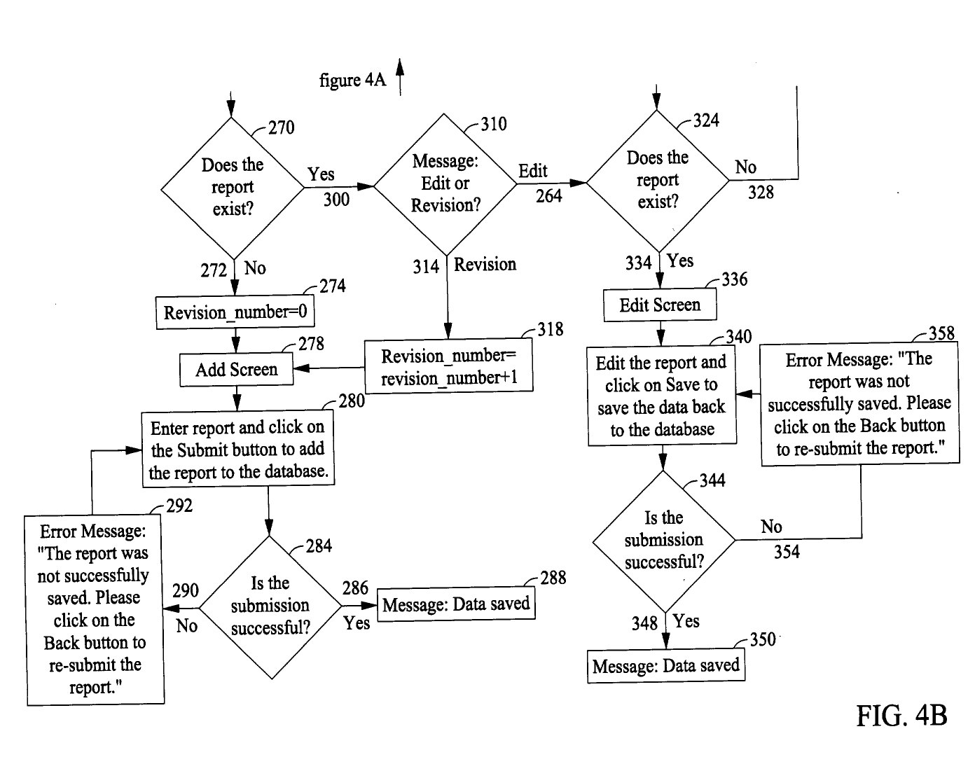

FIG. 4 is a flowchart 200 illustrating an example process for calculating and validating business information by BICS 10. Initially, a user accesses a user interface, such as a menu screen home page 210, of the web site through client system 14 (shown in FIG. 1). In one embodiment, client system 14, as well as server system 12 (shown in FIG. 1), are protected from access by unauthorized individuals. The user logs-in 220 to system 10 using a password (not shown) or an employee payroll number for security. After entering a log-in 220, system 10 determines whether the user has entered a valid user log-in by comparing 230 the entered user log-in 220 to a user table stored on database 20 (shown in FIG. 1). If system 10 determines that an invalid user log-in has been entered 234, system 10 returns the user to log-in page 220 and requests that the user re-enter the log-in. If system 10 determines the user has entered a valid user log-in 236, system 10 displays user interface 210 showing the menu screen for system 10.

Client system 14 then displays options available to the user through links, check boxes, or pull-down lists and enables the user to select 240 the appropriate options. The user selects an add or edit a report based on whether the report being entered is a new report or an existing report. System 10 then determines whether all the options displayed on client system 14 have been selected 246. If all options have not been selected 248, system 10 displays 250 an error message on client system 14 that provides: “All required options have not been selected. Please select the appropriate options and try again.” After the message is displayed 250, system 10 returns the user to re-select options 240. If, however, all options have been selected 256, system 10 enables the user to generate a report based on whether the user has selected to add 260 or edit 264 the report.

If the user has selected to add 260 the report, system 10 searches 270 database 20 to determine whether the report already exists. If system 10 determines that the report does not already exist 272, then system 10 assigns 274 the report a “Revision Number=0,” and displays 278 a screen that enables the user to add the report to system 10. After the user enters the data and selects a Submit button, the report is then entered 280 into system 10 and stored in database 20. System 10 then determines whether the report was successfully submitted 284. If the report was successfully submitted 286, a message is displayed 288 advising that the data was saved. If the report was unsuccessfully submitted 290, an error message is displayed 292 advising that the data was not successfully saved, and the user is returned to the data entry screen to re-enter 280 the report.

If, after selecting to add 260 a report, system 10 determines that the report already exists 300, then system 10 displays a message on client system 14 prompting the user to select whether the user is editing 264 or revising 310 a report. If the user is revising 314 a report, system 10 assigns 318 the report a “Revision Number=Revision Number+1,” and displays 278 a screen that enables the user to add the data to a report in system 10. The report is then entered 280 into system 10 and stored in database 20. If the report is successfully submitted 286, a message is displayed 288 showing that the data was saved. If the report is unsuccessfully submitted 290, an error message is displayed 292 showing that the data was not successfully saved, and the user is returned to the data entry screen to re-enter 280 the report.

If, however, the user selects to edit 264 an existing report, system 10 searches 324 database 20 to determine whether the report already exists. If system 10 determines that the report does not already exist 328, system 10 displays 330 an error message on client system 14 that provides that “This report does not exist in the database. If you would like to Add this report, click on Add button,” and the user is directed back to menu screen 210. If system 10 determines that the report exists 334, then system 10 displays an edit screen 336 on client system 14. The user then edits 340 data in the selected report and clicks on a Save button to save the data to database 20. System 10 then determines whether the report was successfully submitted 344. If the report was successfully submitted 348, a message is displayed 350 showing that the data was saved. If the report was unsuccessfully submitted 354, an error message is displayed 358 showing that the data was not successfully saved, and that the data must be re-submitted. The user is then returned to the data edit screen to edit 340 the data in the report.

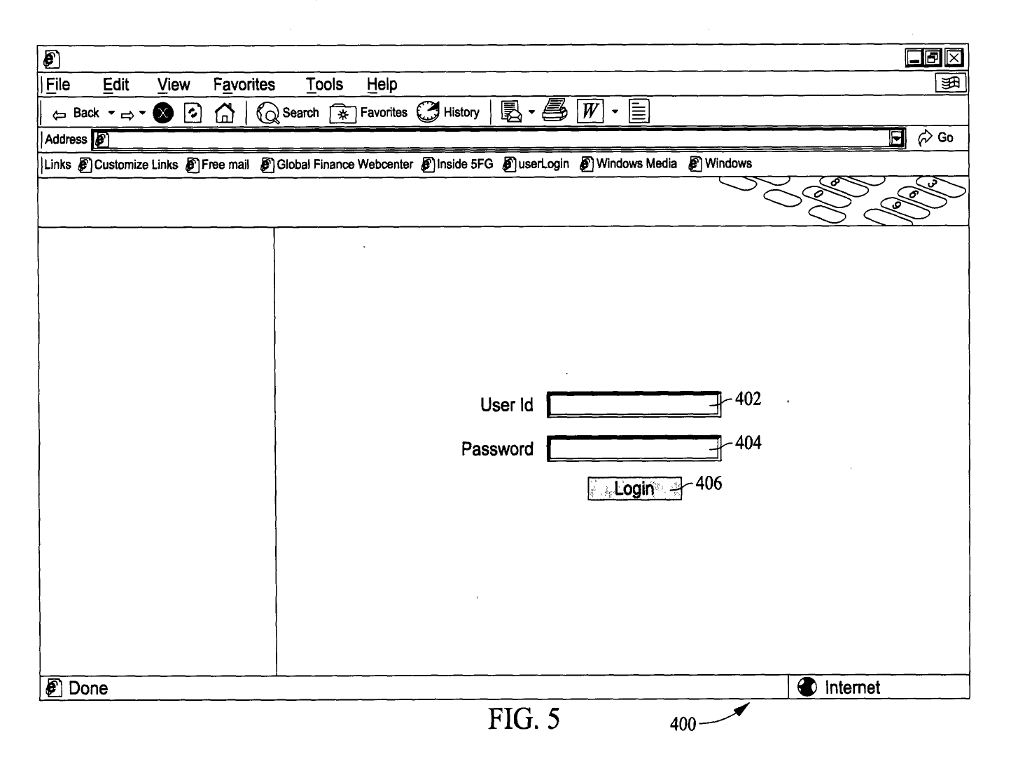

FIG. 5 is an example embodiment of a user interface 400 displaying a login page of BICS 10 (shown in FIG. 1). User interface 400 illustrates a User Id field 402 and a Password field 404. All users must have a user name and password to log-on to BICS 10. In an example embodiment, user interface 400 also shows a “Login” button 406, which is selected by a user after entering an appropriate user name in User Id field 402 and password in Password field 404. Although buttons are shown in the example embodiment, pull-down lists, check boxes, and other means for inputting this information could also be used. User interface 400 is the entry point for anyone trying to access database 20 (shown in FIG. 1). After entering the requested information and selecting Login button 406, the user enters BICS 10.

In the example embodiment, the user name is used for tracking who entered the report into BICS 10, and the password is used for security purposes. A user will be required to enter their assigned user name into User Id field 402 and password into Password field 404, and click on Login button 406. Each user name and corresponding password are stored in a relief users table (not shown in FIG. 5) in database 20. After a user enters a user name and password, BICS 10 determines whether the entered user name and password are stored in the relief users table in database 20. If the entered user name and password are stored in the relief users table, then BICS 10 displays a menu page. If, however, the user name or password is not found in the relief users table, BICS 10 displays a message providing that “You have either entered an invalid user name or password, please try again.”

In the example embodiment, a user interface may also be displayed that enables a user to log in to BICS 10 for the first time, or enables a user to change their password. Once the user has logged in for the first time, the user name will be stored in database 20 with the corresponding password. If, however, a user desires to change their password, using client system 14 the user must enter their old password and the new password twice and then click on a submit button (not shown in FIG. 5). If the old password does not match the password in database 20, BICS 10 will display an error message on client system 14. If the two new sets of passwords do not match, BICS 10 will display an error message on client system 14. If the new password equals the old password, BICS 10 will display an error message on client system 14. Otherwise, BICS 10 will update database 20 with the new password, and will then display the menu page with a message of “Your password has been changed.”

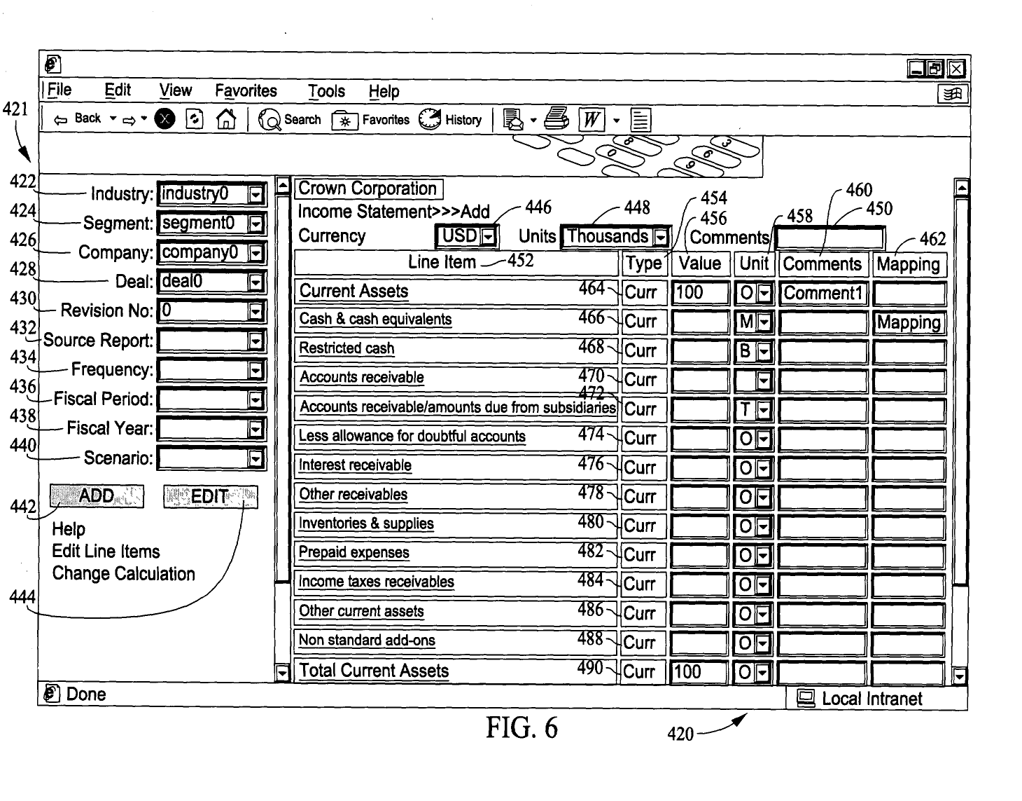

FIG. 6 is an example embodiment of a user interface 420 displaying an income statement report page for a selected Analyzed Business within BICS 10 (shown in FIG. 1) after a user has logged onto BICS 10. User interface 420 displays an income statement report for a selected deal involving the selected Analyzed Business. User interface 420 enables the user to generate a report for the selected Analyzed Business by entering specific business information 120 (shown in FIG. 3) into BICS 10. User interface 420 then calculates other business information 120 based on business information 120 entered into user interface 420. User interface 420 may also be utilized to generate a new report or edit an existing report already stored in database 20 (shown in FIG. 1).

In the example embodiment, user interface 420 includes a plurality of pull-down fields 421 that enable the user to navigate business information 120 stored in database 20. Pull-down fields 421 include the following: an Industry pull-down field 422, a Segment pull-down field 424, a Company pull-down field 426, a Deal pull-down field 428, a Revision No. pull-down field 430, a Source Report pull-down field 432, a Frequency pull-down field 434, a Fiscal Period pull-down field 436, a Fiscal Year pull-down field 438, and a Scenario pull-down field 440. Although pull-down fields 421 are shown in the exemplary embodiment, tabs, check boxes, and other means for inputting this information could also be used. Pull-down fields 421 enable the user to enter specific information that will be utilized by BICS 10 in generating the report. Moreover, pull-down fields 421 may be linked together such that the options displayed in a subsequent pull-down field are based on the options selected in at least one prior pull-down field.

In the example embodiment, Industry pull-down field 422 displays a type of industry that relates to a selected Analyzed Business entered in BICS 10. By entering the type of industry that the Analyzed Business is engaged in through Industry pull-down field 422, a user may view and analyze reports relating to the industry. Segment pull-down field 424 illustrates the business segment that relates to the selected Analyzed Business within BICS 10. Segment pull-down field 424 is linked to Industry pull-down field 422 such that the options displayed under Segment pull-down field 424 are based on the option entered into Industry pull-down field 422.

Company pull-down field 426 illustrates a name of the selected Analyzed Business or the name assigned to the selected Analyzed Business that has a report stored in BICS 10. Deal pull-down field 428 illustrates a specific deal involving the selected Analyzed Business that is being displayed by BICS 10 for which the report is being generated. Revision No. pull-down field 430 illustrates a current revision of the report being displayed and generated. Revision No. pull-down field 430 enables the user to generate, save, and track a plurality of reports for a specific deal involving the selected Analyzed Business. Since much of business information 120 is dynamic, reports may be generated to illustrate business information 120 as it changes over a period of time. A user may want to maintain these reports to enable a historical analysis of business information 120 to be performed with respect to the selected Analyzed Business.

Source Report pull-down field 432 illustrates a source of business information 120 being displayed on user interface 420. Frequency pull-down field 434 illustrates a period of time for which business information 120 is being displayed on user interface 420. In the example embodiment, frequency pull-down field 434 illustrates a monthly, quarterly, or year-to-date frequency. Fiscal Period pull-down field 436 illustrates a month for which business information 120 is being displayed on user interface 420 and for which the report is being generated. Fiscal Year pull-down field 438 illustrates a year for which business information 120 is being displayed on user interface 420 and for which the report is being generated. Scenario pull-down field 440 illustrates a scenario, e.g., Actual, CR Base Case, Budget, and Projection, for which the report is being generated. Scenario pull-down field 440 enables the user to generate and store various scenarios of business information 120 within BICS 10 for analysis, tracking, and predictive purposes.

In the example embodiment, user interface 420 also displays an Add button 442 and an Edit button 444. Add button 442 enables the user to save a new report to database 20 for a selected deal relating to a selected Analyzed Business. Edit button 444 enables the user to edit an existing report for a selected deal relating to a selected Analyzed Business. User interface 420 also displays a Currency pull-down list 446 illustrating the type of currency being utilized on user interface 420, a Units pull-down list 448 illustrating the units being displayed on user interface 420, and a Comments data field 450 that enables a user to enter comments relating to the report. Currency pull-down list 446 enables the user to select US dollars or another type of currency as the type of currency displayed on user interface 420.

In one embodiment, comments entered into BICS 10 by a first user may be electronically transmitted to a second user, including an internal deal team manager, such that the second user can be notified of the first user's review of business information 120 and of any additional data that may be needed to complete the review. Additionally, comments entered into BICS 10 may also include assumptions made by a user when calculating and analyzing business information 120. Such comments, including a summary of the review, request for additional data, and a summary of the assumptions made, may be stored on database 20.

In the example embodiment, user interface 420 displays an income statement report for a selected Analyzed Business. The income statement displayed on user interface 420 includes the following headers for each column: Line Item 452, Type 454, Value 456, Unit 458, Comments 460, and Mapping 462. The income statement displays at least one of a data field, and pull-down data field for each Line Item 452 such that the user can enter data under Value 456, Comments 460, and Mapping 462 for at least one of the Line Items 452.

The income statement displayed on user interface 420 also includes a Current Assets data field 464 followed by a plurality of current asset data fields including: Cash & Cash Equivalents 466, Restricted Cash 468, Accounts Receivable 470, Accounts Receivable/Amounts Due from Subsidiaries 472, Less Allowance for Doubtful Accounts 474, Interest Receivable 476, Other Receivables 478, Inventories & Supplies 480, Prepaid Expenses 482, Income Taxes Receivables 484, Other Current Assets 486, and Non-Standard Add-Ons 488. In the example embodiment, the plurality of current asset data fields may be linked together and may have a formula assigned to the data fields through the linking such that each value entered into the plurality of current asset data fields is totaled and displayed in Current Assets data field 464. User interface 420 also displays a Total Current Assets data field 490 that may also be linked with a formula to Current Assets data field 464.

In the example embodiment, a formula that links the data fields together is entered through Mapping data fields 462. For example, if the value shown in line item data field #3 equals the value entered in line item data field #1 plus the value entered in line item data field #2, then a user may enter such a formula within Mapping data field 462 located adjacent to line item data field #3.

In the example embodiment, as the user enters values for each of the plurality of current asset data fields in the report, the current assets for the selected Analyzed Business will be automatically calculated and displayed in Current Assets data field 464 based on the formula assigned to it. In the example embodiment, the formula assigned to the plurality of current asset data fields and Current Assets data field 464 includes totaling all of the values entered into each of the plurality of current asset data fields and displaying the result in Current Assets data field 464.

In the example embodiment, Current Assets data field 464 is a “flexible field,” and as such the data field is designated with the color green on user interface 420 and within BICS 10. A flexible field is a data field that may be a calculated field or a data entry field. Total Current Assets data field 490 is a “calculation field,” and as such the data field is designated with the color red on user interface 420 and within BICS 10. A calculation field is defined as a data field that is a non-editable calculated field. Each of the plurality of current asset data entries are known as a “detailed field.” A detailed field is defined as part of the formula for the calculation field.

For example, if an Analyzed Business reports only its current assets without a breakdown of those current assets, then the user will enter the value of the current assets for the Analyzed Business in Current Assets data field 464 with no values entered in the detailed fields. In the example case, the value displayed in Total Current Assets data field 490 will equal the value entered into Current Assets data field 464. If, however, an Analyzed Business breaks out the detail for its current assets, then the plurality of current asset data fields, also known as detailed fields, will be filled in, and the Current Assets data field 464, a flexible field, will use a formula saved in database 20 to calculate the total current assets and display that value within Current Assets data field 464 and Total Current Assets data field 490. When the value entered into Current Assets data field 464 is based on data calculated from the detailed fields, the value in Current Assets data field 464 is no longer editable.

In one embodiment, BICS 10 enables a user to access and download files that may contain business information 120 from a document repository such that business information 120 contained in the document repository may be utilized within BICS 10. BICS 10 also enables a user to access and download other data and information that may be utilized within BICS 10, including, but not limited to, accounting reports, tax reports, and engineering reports.

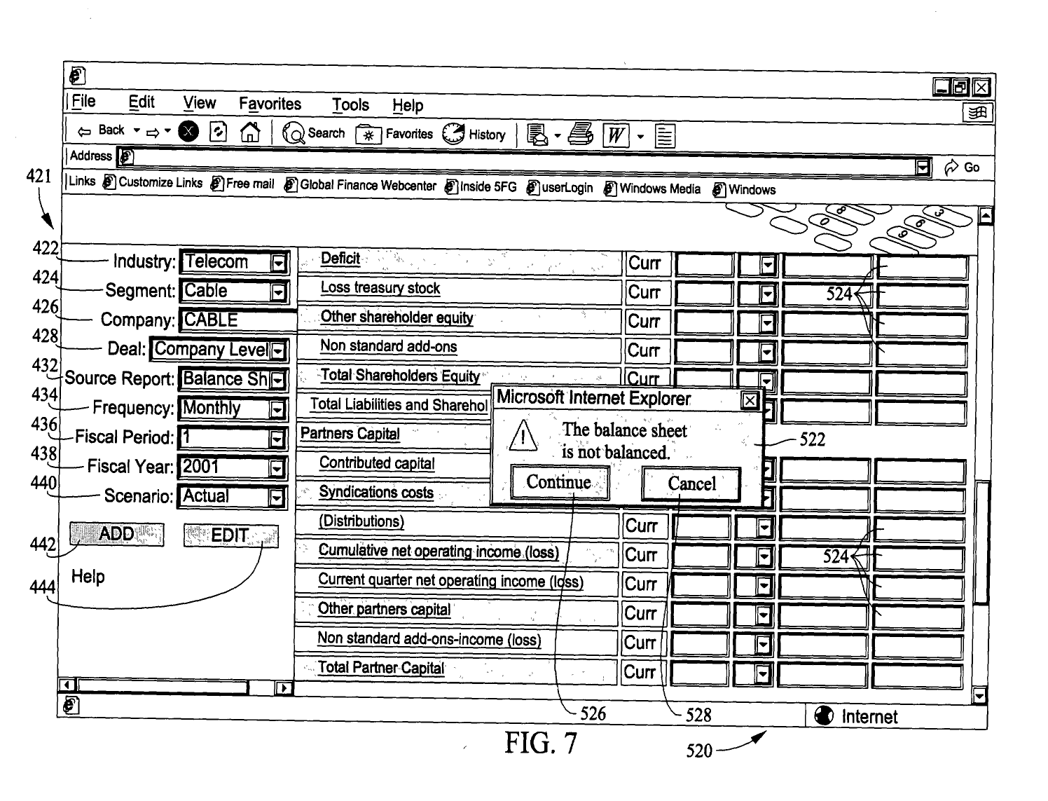

FIG. 7 is an example embodiment of a user interface 520 displaying a validation report page within BICS 10 (shown in FIG. 1) after a user has logged onto BICS 10. Components displayed on user interface 520 that are identical to components displayed on user interface 420 (shown in FIG. 6) are identified on user interface 520 using the same reference numerals as used in FIG. 6. User interface 520 illustrates a balance sheet for a selected Analyzed Business displayed in Company data field 426 (shown in FIG. 6) after BICS 10 has conducted a validation process. BICS 10 enables the user to validate business information 120 (shown in FIG. 3) entered into BICS 10 to confirm that the data has been accurately entered and to confirm that the initial data is correct. In the example embodiment, user interface 520 displays an error message 522 that provides the balance sheet does not balance. Error message 522 is displayed on client system 14 (shown in FIG. 1) after BICS 10 has performed the data validation process and has determined either that the data was not accurately entered or that the data entered is incorrect.

In the example embodiment, user interface 520 also includes plurality of pull-down fields 421 including: Industry pull-down field 422, Segment pull-down field 424, Company pull-down field 426, Deal pull-down field 428, Source Report pull-down field 432, Frequency pull-down field 434, Fiscal Period pull-down field 436, Fiscal Year pull-down field 438, and a Scenario pull-down field 440. Although pull-down fields 421 are shown in the exemplary embodiment, tabs, check boxes, and other means for inputting this information could also be used. Pull-down fields 421 enable the user to enter specific information for which the report will be generated by BICS 10. Moreover, pull-down fields 421 are linked such that the options displayed in a subsequent pull-down field may be based on the option selected in a prior pull-down field.

In the example embodiment, user interface 520 also displays Add button 442 and Edit button 444. Add button 442 enables the user to save a new report to database 20 for the selected Analyzed Business. Edit button 444 enables the user to edit an existing report for the selected Analyzed Business.

In the example embodiment, user interface 520 illustrates a balance sheet for a selected Analyzed Business entered into BICS 10. The balance sheet includes a plurality of data fields 524 that enable the user to input business information 120 (shown in FIG. 3) into user interface 520. Data fields 524 may be linked together and may have formulas assigned to each data fields such that a specific data field may be automatically filled in based on a calculation performed by BICS 10 that involves other data fields. Moreover, by linking the data fields together, BICS 10 may validate the data entered by the user.

For example, in order for a business entity's balance sheet to balance, a business entity's total assets must equal the business entity's total liabilities plus equity. If the entity's total assets do not equal the entity's total liabilities plus equity, the balance sheet does not balance and a further review of the financial data may be required. User interface 520 displays a balance sheet for a selected Analyzed Business within BICS 10 that according to error message 522 does not balance. Thus, after the user has entered business information 120 into BICS 10 and selected Add button 442 or Edit button 444, BICS 10 may conduct a validation process to confirm that the total assets for the selected Analyzed Business as entered into BICS 10 equal its total liabilities plus equity. In other words, BICS 10 may validate that the balance sheet for the selected Analyzed Business balances. If the validation process does not confirm that the balance sheet is balanced, BICS 10 displays message 522 on client system 14 advising the user that the balance sheet is not balanced. Thus, BICS 10 enables the user to validate business information 120 entered into BICS 10 to confirm that the data has been accurately entered, or to confirm that the data gathered and entered into BICS 10 is correct.

In the example embodiment, user interface 520 also includes a Continue button 526 and a Cancel button 528 on message 522. If the user selects Continue button 526, the report including the unbalanced balance sheet will be save in database 20. If the user selects Cancel button 528, the report will not be save and the previous report will remain in database 20 for future editing.

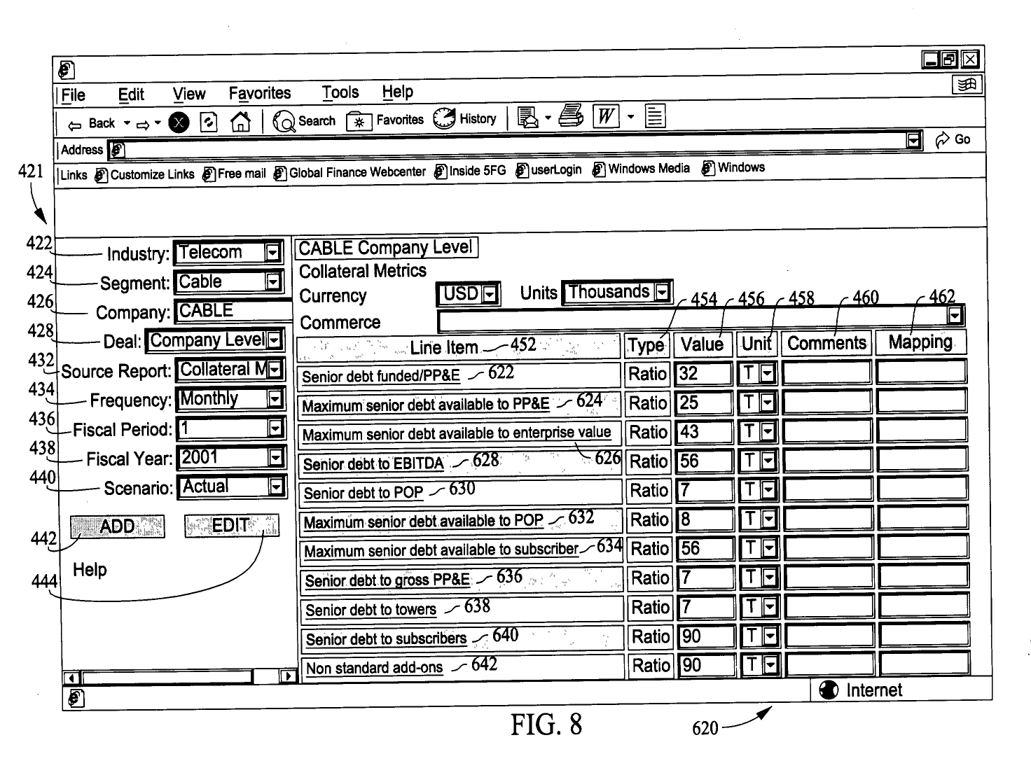

FIG. 8 is an exemplary embodiment of a user interface 620 displaying a metrics calculation and financial ratios report page relating to an Analyzed Business within BICS 10 (shown in FIG. 1) after a user has logged onto BICS 10. Components displayed on user interface 620 that are identical to components displayed on user interface 420 (shown in FIG. 6) are identified on user interface 620 using the same reference numerals as used in FIG. 6. User interface 620 illustrates a collateral metrics and financial ratios report page for a selected Analyzed Business displayed in Company data field 426 (shown in FIG. 6).

In the example embodiment, user interface 620 includes plurality of pull-down fields 421 that enable a user to enter business information 120 (shown in FIG. 3) to navigate BICS 10. Pull-down fields 421 include at least the following: Industry pull-down field 422, Segment pull-down field 424, Company pull-down field 426, Deal pull-down field 428, Source Report pull-down field 432, Frequency pull-down field 434, Fiscal Period pull-down field 436, Fiscal Year pull-down field 438, and a Scenario pull-down field 440. Although pull-down fields 421 are shown in the exemplary embodiment, tabs, check boxes, and other means for inputting this information could also be used. Pull-down fields 421 enable the user to enter specific information for which the report will be generated by BICS 10. Moreover, pull-down fields 421 may be linked together such that the options displayed in a subsequent pull-down field may be based on the option selected in a prior pull-down field.

In the example embodiment, user interface 620 also displays Add button 442 and Edit button 444. Add button 442 enables the user to save a new collateral metrics and financial ratios report to database 20 for the selected Analyzed Business. Edit button 444 enables the user to edit an existing collateral metrics and financial ratios report for the selected Analyzed Business.

In the example embodiment, user interface 620 illustrates a collateral metrics and financial ratios report page for a selected Analyzed Business within BICS 10. The collateral metrics and financial ratios report displayed on user interface 620 includes the following column headers: Line Item 452, Type 454, Value 456, Unit 458, Comments 460, and Mapping 462. The collateral metrics and financial ratios report also displays at least one of a data field, and a pull-down data field for each Line Item 452 such that the user can enter data under Value 456, Comments 460, and Mapping 462 for at least one of the Line Items 452.

In the example embodiment, the collateral metrics and financial ratios report displayed on user interface 620 also includes a plurality of data fields including: Senior Debt Funded/PP&E 622, Maximum Senior Debt Available to PP&E 624, Maximum Senior Debt Available to Enterprise Value 626, Senior Debt to EBITDA 628, Senior Debt to POP 630, Maximum Senior Debt Available to POP 632, Maximum Senior Debt Available to Subscriber 634, Senior Debt to Gross PP&E 636, Senior Debt to Towers 638, Senior Debt to Subscribers 640, and Non-Standard Add-Ons 642.

In the example embodiment, the data fields displayed on user interface 620 are calculated based on data entered in other reports within BICS 10. These calculations are conducted utilizing at least one of a SQL procedure or Java® code that runs on a nightly basis. When the calculation fields within BICS 10 have data entered into them or data changed within them, BICS 10 calculates and saves the data in a company data table (not shown in FIG. 8) in database 20. In another embodiment, if BICS 10 requires additional time to run the calculations, the calculations may be conducted behind a “calculate now” button (not shown) within the reports. In another embodiment, if the calculations do not require a substantial amount of time, the calculation may be conducted each time a report, e.g., Balance Sheet, Income Statement, Operating Metric, is submitted to BICS 10. In another embodiment, if the calculations do require a substantial amount of time to conduct, BICS 10 may be configured to conduct the calculations at night when BICS 10 is utilized on a more limited basis.

In the example embodiment, for a financial ratio report with Scenario 440 of “Actual,” BICS 10 is configured such that it calculates the ratios displayed in the report with the latest Revision Number. For example: if a user wishes to calculate total assets to total liabilities for a selected Analyzed Business having three different revisions for its Actual Balance Sheets, BICS 10 will divide the total current assets by the total current liabilities as they appear in Revision No. 3 of the Balance Sheet. For a Scenario 440 of “Base Case,” “Budget” and “Projection,” BICS 10 is configured such that it matches the Revision Number for the Financial Ratio Report, the Balance Sheet, and the Income Statement. For example: if an Analyzed Business has three different revisions for the Budget Balance Sheet, BICS 10 will generate three different Financial Ratio Reports; one for each of the three different Budget Balance Sheets. Database 20 stores the data for each revision, but only the latest revision of the Financial Ratio Report is displayed on client system 14. With respect to each collateral metrics report, BICS 10 is configured to only generate “Actual” reports as displayed in Scenario pull-down filed 440. For Actual reports, BICS 10 utilizes the values in the report having the latest Revision Number. In the example embodiment, these logics are built into the SQL procedure or Java® code.

In the example embodiment, the income statement shown on user interface 420 (shown in FIG. 6), the balance sheet shown on user interface 520 (shown in FIG. 7), and the collateral metrics and financial ratios report displayed on user interface 620 (shown in FIG. 8) are standardized templates stored in BICS 10 that enable a user to enter business information 120 into BICS 10 such that a portfolio-wide analysis or a multiple business-wide analysis may be performed by BICS 10. The portfolio-wide analysis or multiple business-wide analysis may include an analysis of certain businesses stored within BICS 10 that are in a similar industry. BICS 10 also enables the user to track or map the source, e.g., a specific business report for the Analyzed Business, of specific business information entered into BICS 10 via the standardized templates.

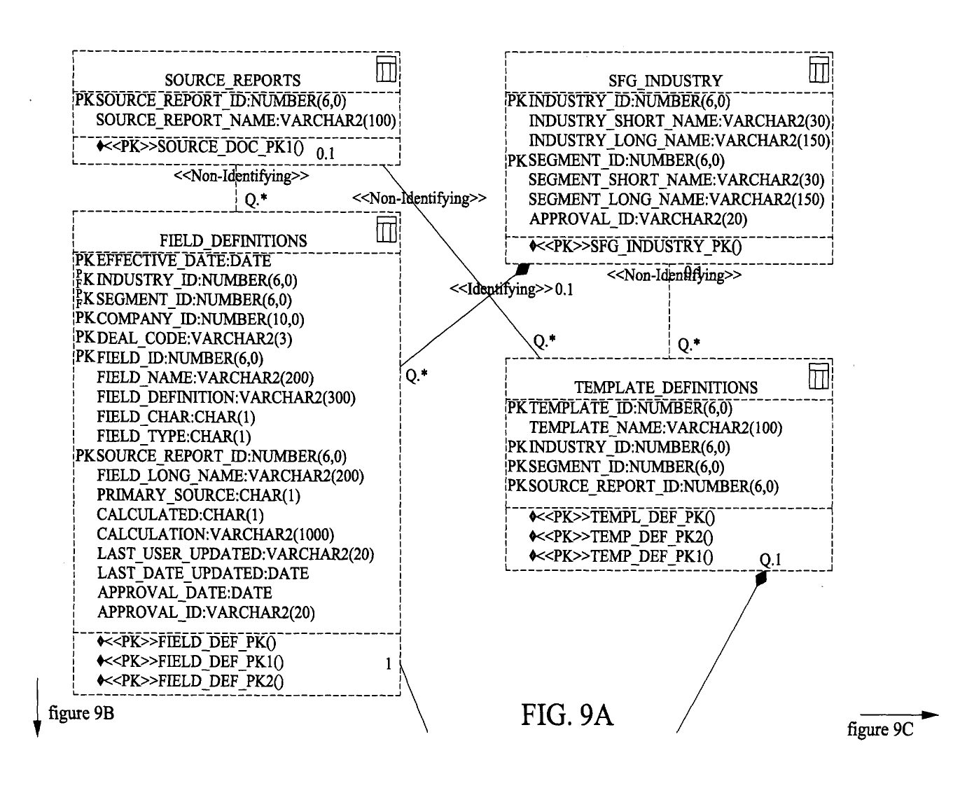

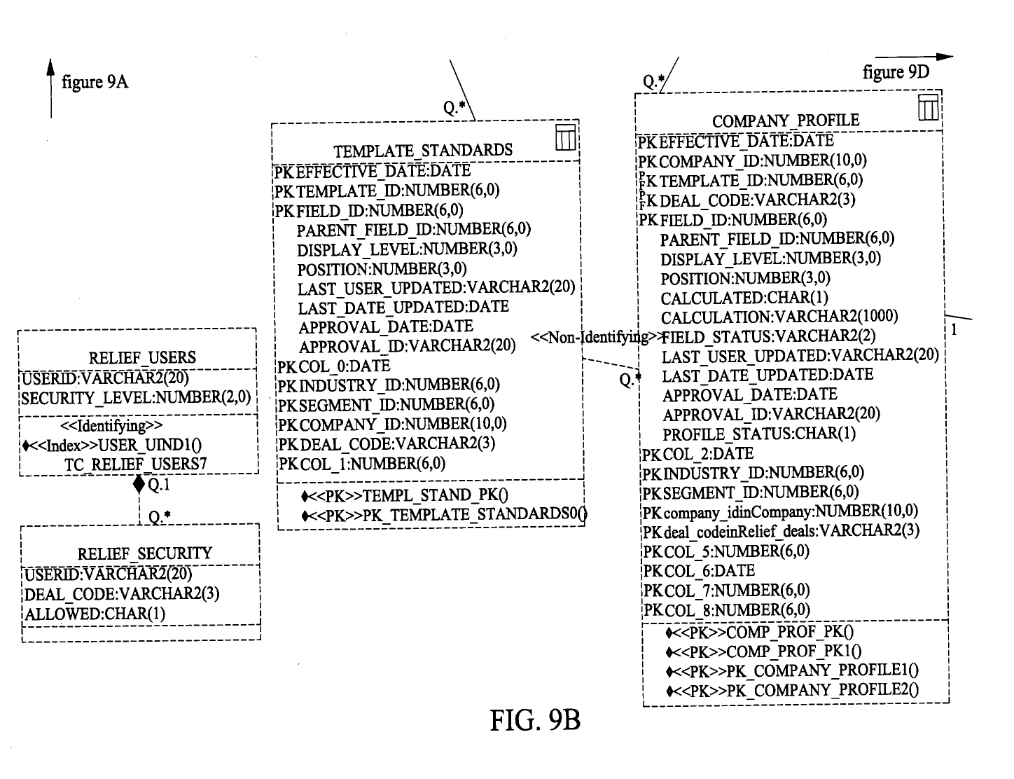

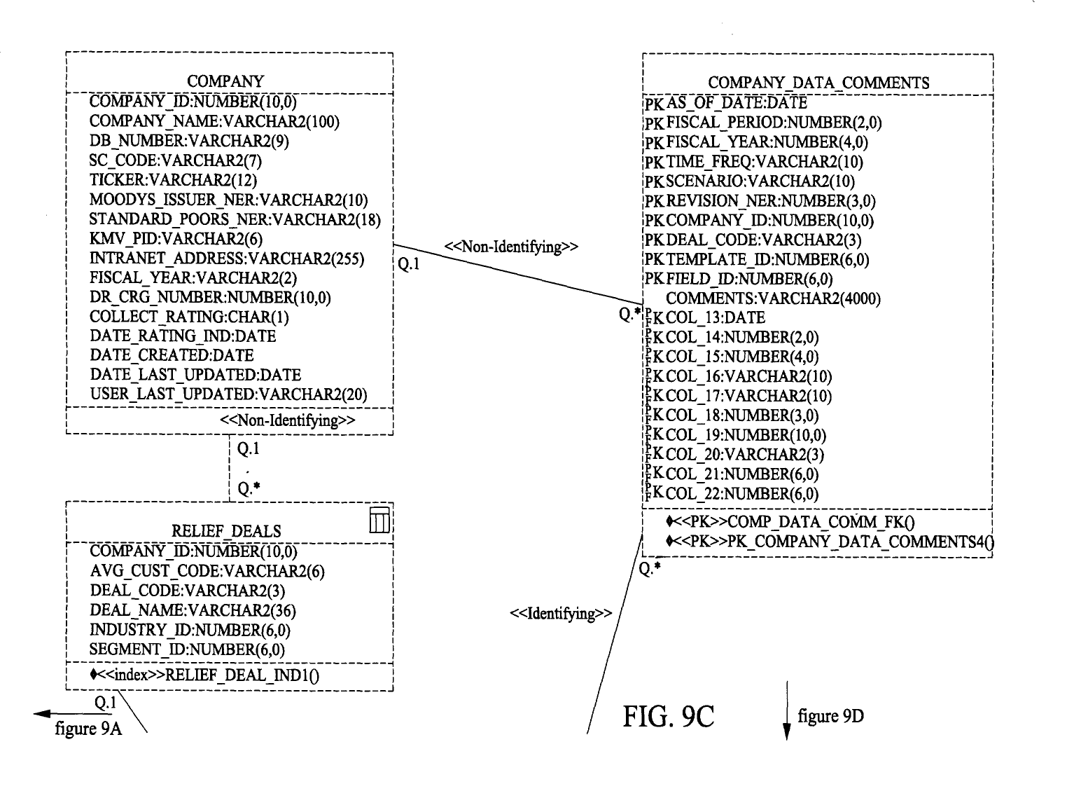

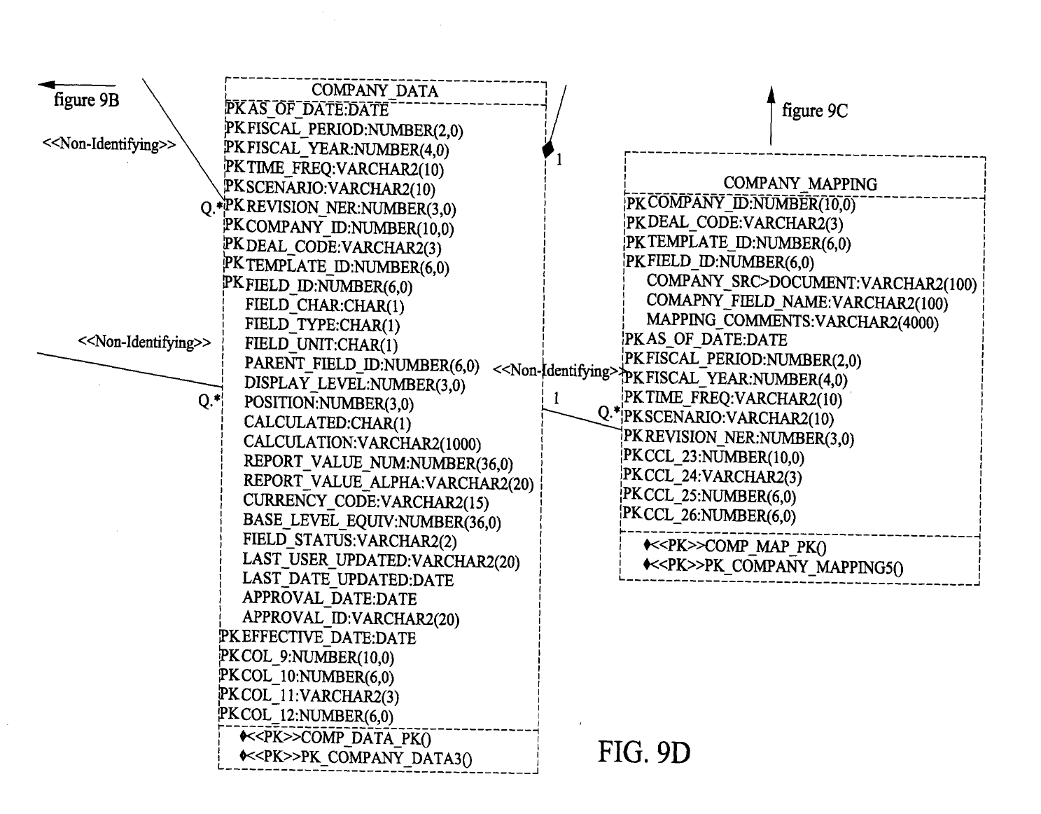

FIG. 9 is an entity relationship diagram for an example embodiment of BICS 10.

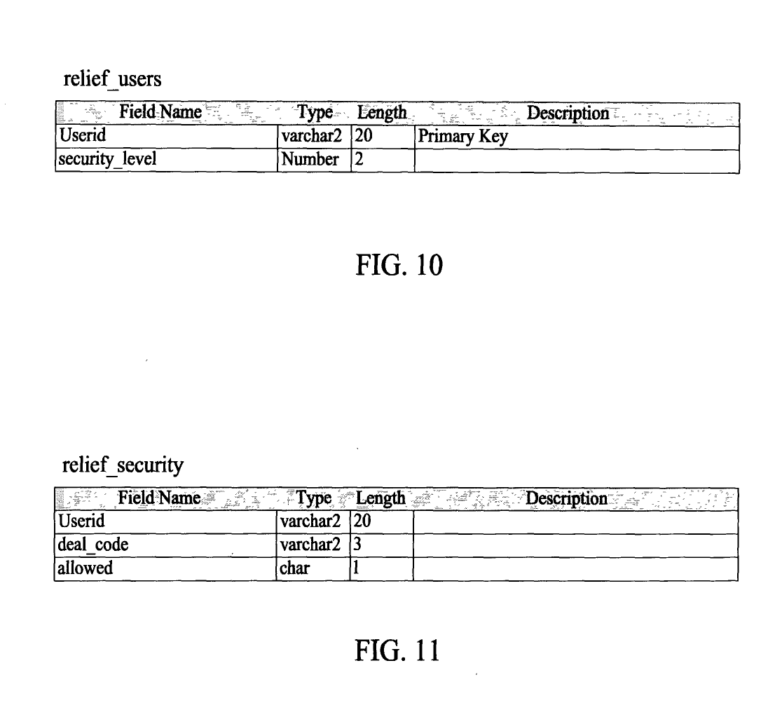

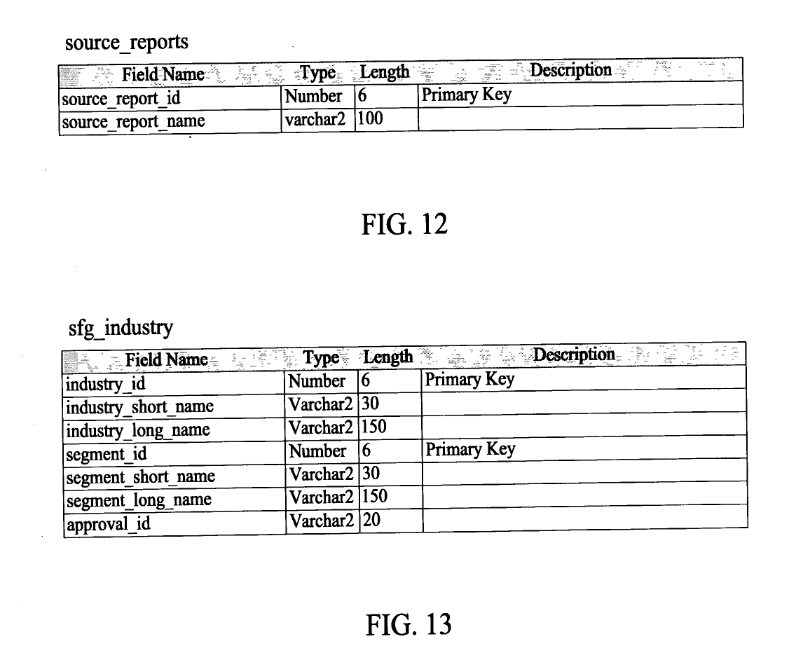

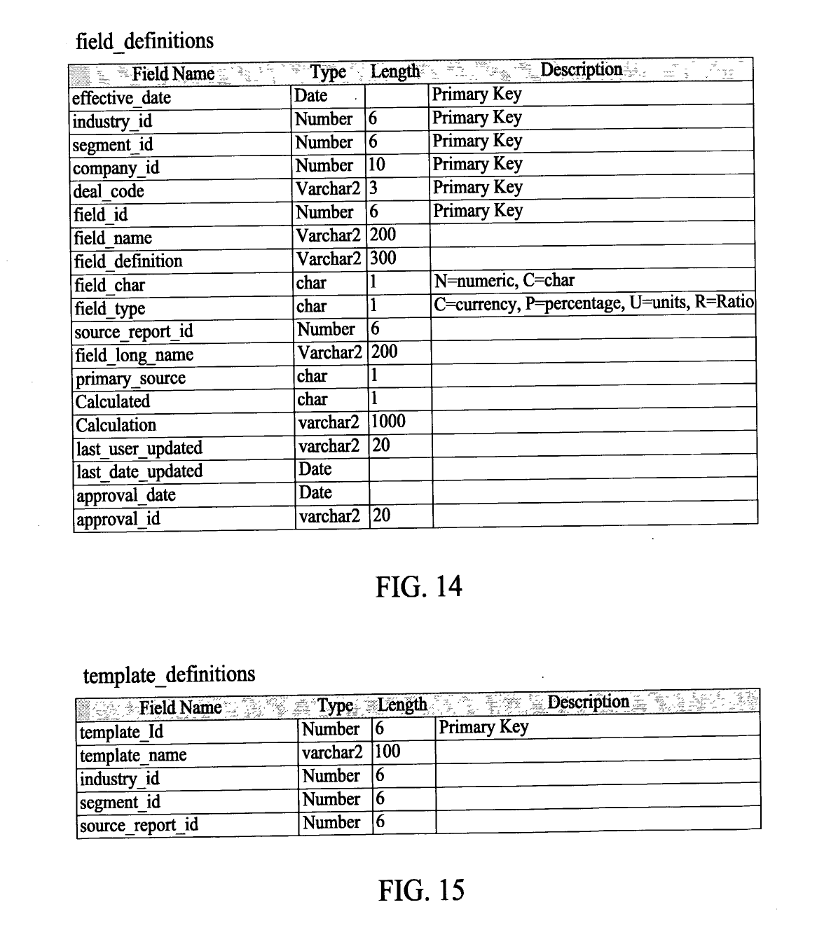

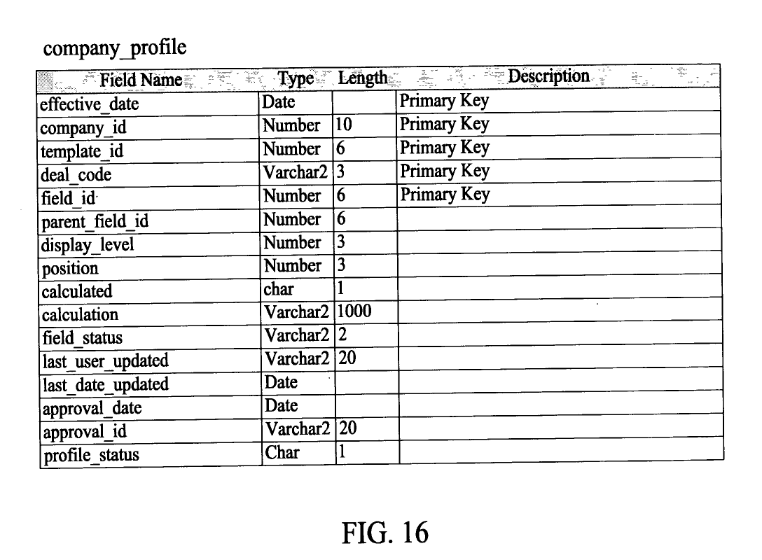

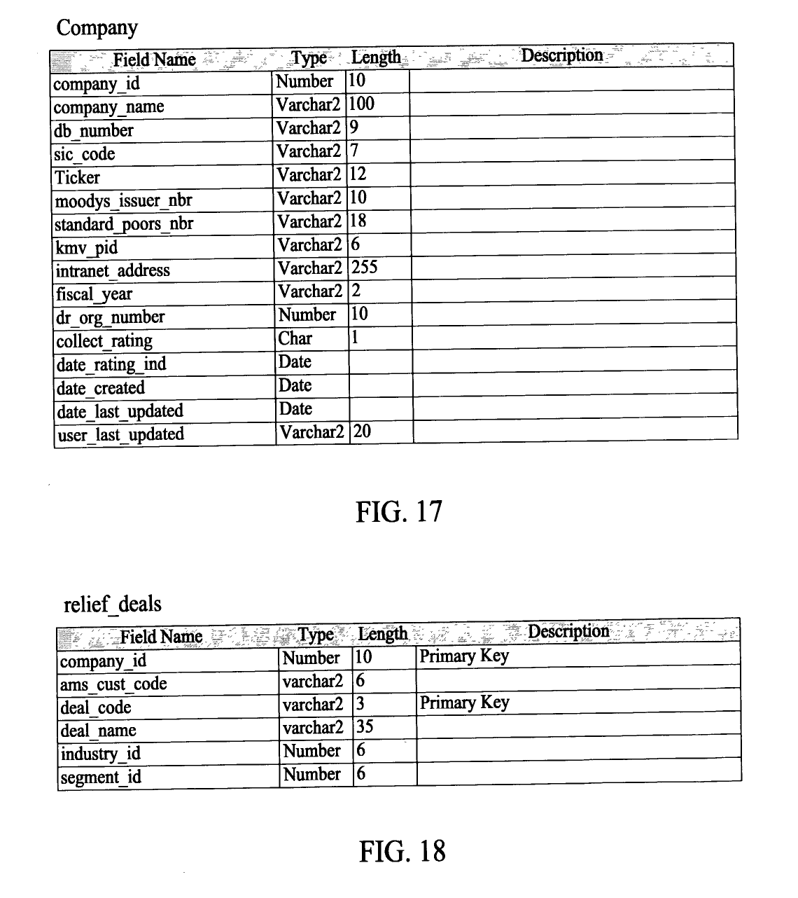

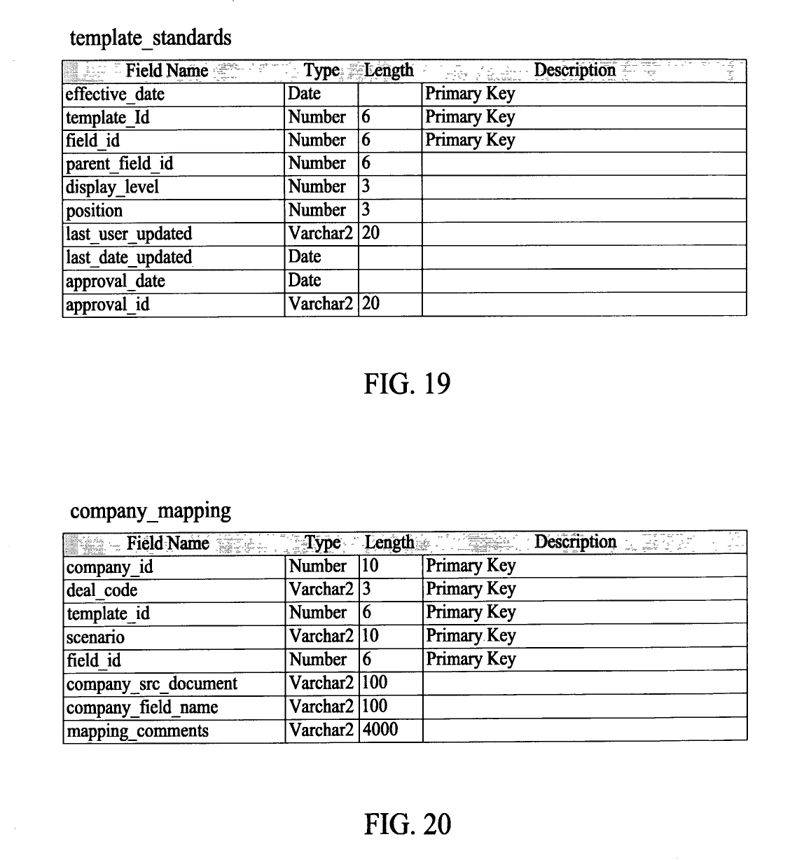

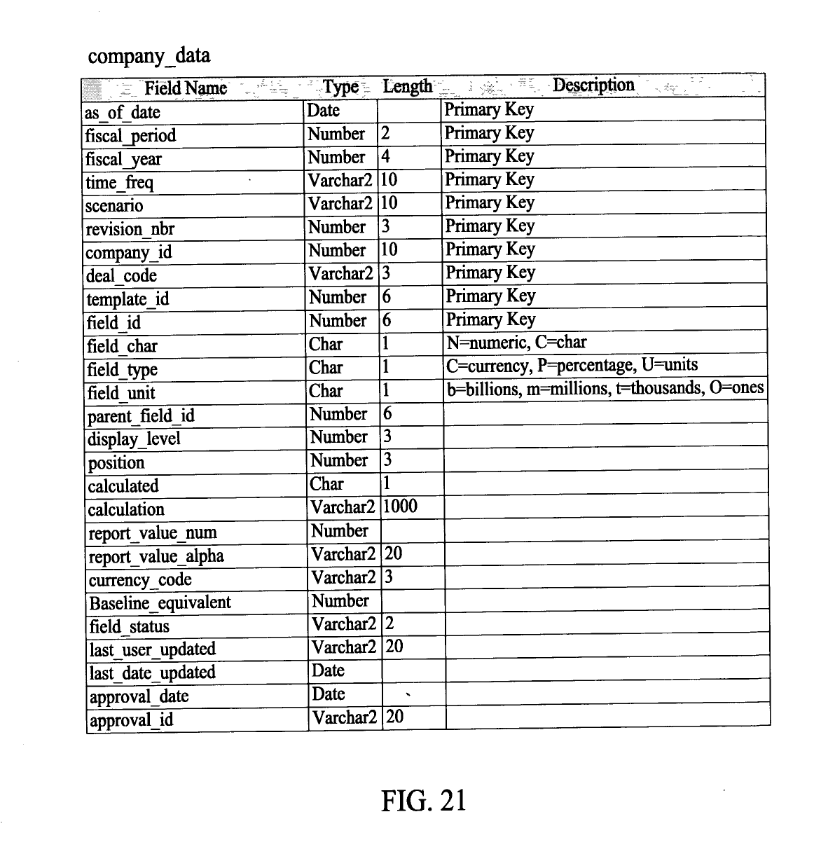

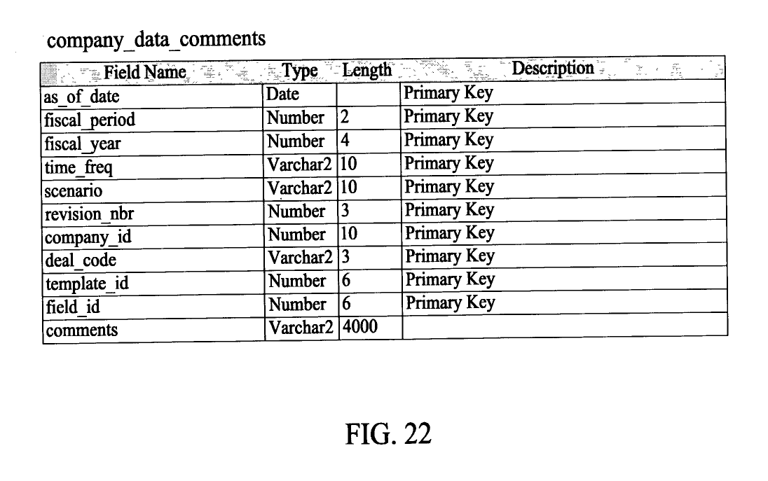

FIGS. 10-22 are at least some of the data tables and key fields used by BICS 10.

The BICS therefore better enables a business engaging in complex deals, such as commercial financing, mergers, and acquisitions, to collect, manage, store, and disseminate business information among internal deal teams to facilitate a more accurate and efficient exchange of information. More specifically, the BICS enables a user to input business information relating to an Analyzed Business during a single occasion and into a single computer workstation that may be located at various locations. In addition, the BICS permits the internal deal teams within the SF Business to share business information relating to the Analyzed Business. The BICS also enables a user to summarize its business information from a plurality of sources, calculate other business information based on the entered business information, and validate the business information to confirm that it was accurately entered and correct. The BICS also enables the user to maintain and evaluate previously received business information, and compare it to newly received business information. Also, the BICS enables a user to electronically transmit a report to an internal deal team manager relating to a review of the business information by a user. Thus, the BICS permits the SF Business to devote more time to analyzing the business information, and less time entering, checking and reporting data.

While the invention has been described in terms of various specific embodiments, those skilled in the art will recognize that the invention can be practiced with modification within the spirit and scope of the claims.

What is claimed is:

1. A method for managing business information by a first business entity using a server system coupled to a centralized database and at least one client system, said method comprising:
receiving at the server system business information relating to at least one second business entity through the client system;
calculating business information based on the business information previously entered through the client system;
generating a plurality of reports based on the business information;
validating the business information contained in the reports; and
storing the business information and the generated reports in the centralized database.

2. A method in accordance with claim 1 further comprising:
updating the centralized database periodically with newly received business information;
generating a plurality of new reports based on the newly received business information; and
storing previously received business information, previously generated reports, newly received business information and newly generated reports in the centralized database.

3. A method in accordance with claim 2 wherein updating the centralized database periodically with newly received business information and newly generated reports comprises at least one of:
adding newly received business information to the server system and generating a plurality of new reports therefrom, and storing newly added business information and newly generated reports in the centralized database;
editing existing business information and existing reports generated therefrom stored in the centralized database with newly received business information such that edited business information and edited reports are stored in the centralized database replacing existing business information and existing reports; and
revising existing business information and generating a plurality of revised reports therefrom such that revised business information, revised reports are stored in the centralized database with existing business information and existing reports.

4. A method in accordance with claim 2 further comprising:
receiving a request for previously received business information, previously generated reports, newly received business information, and newly generated reports through the client system;
tracking business information and reports stored in the centralized database such that at least one of previously received business information, previously generated reports, newly received business information, and newly generated reports is retrievable from the centralized database; and
providing the requested business information and reports in response to the request.

5. A method in accordance with claim 4 wherein tracking business information and the plurality of reports comprises determining whether business information and the plurality of reports generated therefrom are at least one of newly added, edited, and revised.

6. A method in accordance with claim 4 wherein tracking business information and the plurality of reports further comprises:
assigning a revision number to business information and each of the plurality of reports generated therefrom when the business information and the reports are stored in the centralized database;
sequentially updating the revision number assigned to the business information and each of the plurality of reports generated therefrom when a user revises the business information and the reports generated therefrom stored in the centralized database; and
tracking the revision number assigned to the business information and each of the plurality of reports stored in the centralized database.

7. A method in accordance with claim 4 wherein providing business information comprises:
displaying a plurality of pull-down data fields including at least one of an industry, a segment, a company, and a deal on the client system that prompt a user to select a predesignated second business entity to manage;
receiving an inquiry from the client system regarding the selected second business entity; and
displaying at least one of business information and reports on the client system for review by an authorized user.

8. A method in accordance with claim 4 wherein providing business information comprises:
displaying information on the client system regarding at least one of an industry, a segment, a company name, a deal, operating metrics, cash flow statements, an availability analysis, a covenant compliance, coverage ratios, financial statements, a capital structure, income statements, a leverage analysis, collateral, guarantors, a liquidation value, and an equity valuation for each second business entity; and
receiving an inquiry from the client system regarding at least one of an industry, a segment, a company name, a deal, operating metrics, cash flow statements, an availability analysis, a covenant compliance, coverage ratios, financial statements, a capital structure, income statements, a leverage analysis, collateral, guarantors, a liquidation value, and an equity valuation for each second business entity.

9. A method in accordance with claim 4 wherein providing business information comprises:
accessing the centralized database;
searching the database regarding the specific inquiry;
retrieving information from the database; and
transmitting the retrieved information to the client system for display by the client system.

10. A method in accordance with claim 1 wherein receiving business information comprises receiving business information that includes at least one of an industry, a segment, a company name, a deal, operating metrics, cash flow statements, an availability analysis, a covenant compliance, coverage ratios, financial statements, a capital structure, income statements, a leverage analysis, collateral, guarantors, a liquidation value, an equity valuation, and other documents and information relating to the financial condition for each second business entity.

11. A method in accordance with claim 1 wherein receiving business information comprises receiving business information through the client system for review by at least one of a manager within the first business entity and other authorized users.

12. A method in accordance with claim 1 wherein receiving business information comprises receiving business information through a plurality of templates displayed on the client system including at least one of an income statement, a balance sheet, a collateral metrics report, and a financial ratios report.

13. A method in accordance with claim 1 wherein receiving business information comprises receiving business information through a plurality of templates displayed on the client system including at least one of an income statement, a balance sheet, a collateral metrics report, and a financial ratios report such that a user may perform at least one of a portfolio-wide analysis and a multiple business-wide analysis.

14. A method in accordance with claim 1 wherein receiving business information comprises importing business information from a plurality of computer programs through the client system.

15. A method in accordance with claim 1 wherein calculating business information comprises linking together data fields included within at least one of the plurality of reports and assigning a formula to the linked data fields such that data entered into detailed data fields is inputted into the assigned formula and the resulting value is displayed in a calculation data field.

16. A method in accordance with claim 1 wherein calculating business information comprises linking together data fields included within the plurality of reports and assigning a formula to the linked data fields such that data entered into detailed data fields is inputted into the assigned formula and the resulting value is displayed in a calculation data field.

17. A method in accordance with claim 1 wherein calculating business information comprises calculating at least one of an income statement, a balance sheet, a collateral metrics report, and a financial ratios report.

18. A method in accordance with claim 1 wherein calculating business information comprises calculating a plurality of scenarios including at least one of an Actual, a Base Case, a Budget, and a Projection for analysis, tracking, and forecasting purposes.

19. A method in accordance with claim 1 wherein validating the business information contained in the reports comprises linking together data fields included within at least one of the plurality of reports and assigning a formula to the linked data fields to assure that the business information received through the client system is accurate and correct.

20. A method in accordance with claim 1 wherein validating the business information contained in the reports comprises linking together data fields included within the plurality of reports and assigning a formula to the linked data fields to assure that the business information received through the client system is accurate and correct.

21. A method in accordance with claim 1 further comprising connecting the client system and the server system via a network that includes one of a wide area network, a local area network, an intranet and the Internet.

22. A method for managing business information by a first business entity using a server system coupled to a centralized database, at least one managerial user system, and at least one client system, said method comprising:
receiving at the server system business information relating to at least one second business entity through the client system;
calculating business information based on business information previously entered through the client system;
generating a plurality of reports based on the business information;
validating the business information contained in the reports;
storing the business information and the plurality of reports generated therefrom in the centralized database;
updating the centralized database periodically with newly received business information and a newly generated plurality of reports;
tracking the business information and reports stored in the centralized database;
receiving a request for at least one of business information and reports through the client system;
providing the requested business information and reports in response to the request; and
providing a report to at least one managerial user system relating to a review by a user of the business information and the plurality of reports generated therefrom.

23. A method in accordance with claim 22 wherein receiving business information comprises receiving business information through a plurality of templates displayed on the client system including at least one of an income statement, a balance sheet, a collateral metrics report, and a financial ratios report.

24. A method in accordance with claim 22 wherein receiving business information comprises receiving business information through a plurality of templates displayed on the client system including at least one of an income statement, a balance sheet, a collateral metrics report, and a financial ratios report which display a source of the business information being received.

25. A method in accordance with claim 22 wherein calculating business information comprises:
linking together data fields included within at least one of the plurality of reports and assigning a formula to the linked data fields such that data entered into detailed data fields is inputted into the assigned formula and the resulting value is displayed in a calculation data field; and
linking together data fields included within the plurality of reports and assigning a formula to the linked data fields such that data entered into detailed data fields is inputted into the assigned formula and the resulting value is displayed in a calculation data field.

26. A method in accordance with claim 22 wherein validating the business information contained in the reports comprises:
linking together data fields included within at least one of the plurality of reports and assigning a formula to the linked data fields to assure that the business information received through the client system is accurate and correct; and
linking together data fields included within the plurality of reports and assigning a formula to the linked data fields to assure that the business information received through the client system is accurate and correct.

27. A method in accordance with claim 22 wherein updating the centralized database periodically with newly received business information and newly generated reports comprises at least one of:
adding newly received business information to the server system and generating a plurality of new reports therefrom, and storing newly added business information and newly generated reports in the centralized database;
editing existing business information and existing reports generated therefrom stored in the centralized database with newly received business information such that edited business information and edited reports are stored in the centralized database replacing existing business information and existing reports; and
revising existing business information and generating a plurality of revised reports therefrom such that revised business information and revised reports are stored in the centralized database with existing business information and existing reports.

28. A method in accordance with claim 22 wherein tracking business information and the plurality of reports comprises:
assigning a tracking number to business information and each of the plurality of reports generated therefrom when the business information and the reports are stored in the centralized database;
sequentially updating the tracking number assigned to the business information and each of the plurality of reports generated therefrom when a user revises the business information and the reports generated therefrom stored in the centralized database; and
tracking the tracking number assigned to the business information and each of the plurality of reports stored in the centralized database.

29. A method in accordance with claim 28 wherein assigning a tracking number further comprises assigning a revision number to business information and each of the plurality of reports generated therefrom when the business information and the reports are stored in the centralized database such that the server system tracks and displays on the client system the revision number assigned to the business information and each of the plurality of reports.

30. A method in accordance with claim 22 wherein providing business information comprises:
displaying a plurality of pull-down data fields including at least one of an industry, a segment, a company, and a deal on the client system that prompt a user to select a predesignated second business entity;
receiving an inquiry from the client system regarding the selected second business entity; and
displaying at least one of business information and reports on the client system for review by an authorized user.

31. A method in accordance with claim 22 wherein providing a report to at least one managerial user system comprises:
entering comments through the client system into a data field provided within each of the plurality of reports wherein the comments relate to a review by a user of the business information and the plurality of reports generated therefrom; and
transmitting the reports that include the comments to at least one manager within the first business entity from the user such that managerial oversight of the business information is facilitated.

32. A network based system for managing business information by a first business entity, said system comprising:
a client system comprising a browser;
a centralized database for storing information;
a server system configured to be coupled to said client system and said database, said server system further configured to:
receive business information relating to at least one second business entity from said client system;
calculate business information based on business information previously entered through said client system;
generate a plurality of reports based on business information;
validate the business information contained in said reports;
store the business information and the plurality of reports generated therefrom in said centralized database;
update said centralized database periodically with newly received business information and a newly generated plurality of reports;
track business information and reports stored in said centralized database;
receive a request for at least one of business information and reports through said client system; and
provide the requested business information and reports in response to the request.

33. A system in accordance with claim 32 wherein said server system is further configured to provide a report to at least one of a manager within said first business entity and other authorized users relating to a review by a user of said business information and the plurality of reports generated therefrom.

34. A system in accordance with claim 32 wherein said business information comprises at least one of an industry, a segment, a company name, a deal, operating metrics, cash flow statements, an availability analysis, a covenant compliance, coverage ratios, financial statements, a capital structure, income statements, a leverage analysis, collateral, guarantors, a liquidation value, an equity valuation, and other documents and information relating to the financial condition for each of said second business entities.

35. A system in accordance with claim 32 wherein said client system further comprises at least one of:
a displaying component for displaying at least one of a pull-down list, a check box, a data field, and hypertext link options relating to the business information;
a sending component to send an inquiry to said server system so that said server system can process and download the requested information to said client system;
a collection component for collecting business information from users into said centralized database;
a tracking component for tracking business information;
a displaying component for displaying business information for each of said second business entities;
a receiving component for receiving an inquiry from said client system regarding at least one of an industry, a segment, a company name, a deal, operating metrics, cash flow statements, an availability analysis, a covenant compliance, coverage ratios, financial statements, a capital structure, income statements, a leverage analysis, collateral, guarantors, a liquidation value, and an equity valuation for each of said second business entities and a selected group of said second business entities;
an accessing component for accessing said centralized database and causing the retrieved information to be displayed on said client system;
a processing component for calculating business information based on the business information collected, generating a plurality of reports based on the business information collected, and validating the business information included in the reports;
an updating component for updating said centralized database periodically with newly received business information and a newly generated plurality of reports; and
a notifying component for transmitting a report from a user to at least one manager within said first business entity wherein said report relates to a review by said user of the business information and the plurality of reports generated therefrom.

36. A system in accordance with claim 32 wherein said server system further comprises a receiving component for receiving an inquiry to provide information from one of a plurality of users.

37. A system in accordance with claim 32 wherein said server system further comprises a processing component for searching and processing received inquiries against said database containing information collected by said collection component, and for tracking said business information.

38. A system in accordance with claim 32 wherein said server system further comprises a retrieving component to retrieve business information from said database.

39. A system in accordance with claim 32 wherein said server system further comprises an information fulfillment component that downloads the requested information after retrieving from said database.

40. A system in accordance with claim 32 wherein said server system further comprises a receiving component that receives an inquiry from said client system regarding at least one of an industry, a segment, a company name, a deal, operating metrics, cash flow statements, an availability analysis, a covenant compliance, coverage ratios, financial statements, a capital structure, income statements, a leverage analysis, collateral, guarantors, a liquidation value, an equity valuation, and other documents and information relating to the financial condition of each of said second business entities.

41. A system in accordance with claim 32 wherein said server system further comprises a receiving component that receives business information through a plurality of templates displayed on said client system including at least one of an income statement, a balance sheet, a collateral metrics report, and a financial ratios report.

42. A system in accordance with claim 32 wherein said server system further comprises a calculation component that calculates business information by linking together data fields included within at least one of the plurality of reports and assigning a formula to said linked data fields such that data entered into detailed data fields is inputted into said assigned formula and a resulting value is displayed in a calculation data field.

43. A system in accordance with claim 32 wherein said server system further comprises a calculation component that calculates business information by linking together data fields included within the plurality of reports and assigning a formula to said linked data fields such that data entered into detailed data fields is inputted into said assigned formula and a resulting value is displayed in a calculation data field.

44. A system in accordance with claim 32 wherein said server system further comprises a calculation component that calculates a plurality of scenarios including at least one of an Actual, a Base Case, a Budget, and a Projection for analysis, tracking, and forecasting purposes.

45. A system in accordance with claim 32 wherein said server system further comprises a validation component that validates business information by performing at least one of:
linking together data fields included within at least one of the plurality of reports and assigning a formula to said linked data fields to assure that the business information received through said client system is accurate and correct; and
linking together data fields included within the plurality of reports and assigning a formula to said linked data fields to assure that the business information received through said client system is accurate and correct.

46. A system in accordance with claim 32 wherein said server system further comprises an updating component that updates said centralized database by performing at least one of:
adding newly received business information to said server system and generating a plurality of new reports therefrom, and storing newly added business information and newly generated reports in said centralized database;
editing existing business information and existing reports generated therefrom stored in said centralized database with newly received business information such that edited business information and edited reports are stored in said centralized database replacing existing business information and existing reports; and
revising existing business information and generating a plurality of revised reports therefrom such that revised business information and revised reports are stored in said centralized database with existing business information and existing reports.

47. A system in accordance with claim 32 wherein said server system further comprises a tracking component that tracks business information and the plurality of reports by:
assigning a tracking number to business information and each of the plurality of reports generated therefrom when the business information and the reports are stored in said centralized database;
sequentially updating said tracking number assigned to the business information and each of the plurality of reports generated therefrom when a user revises the business information and the reports generated therefrom stored in said centralized database; and
tracking said tracking number assigned to the business information and each of the plurality of reports stored in said centralized database.

48. A system in accordance with claim 47 wherein said tracking number comprises a revision number that illustrates each time business information and each of the plurality of reports generated therefrom are revised by a user.

49. A system in accordance with claim 32 wherein said server system further comprises a web server and an application server, said web server in communication with said application server and said client system, said application server in communication with said web server and said centralized database.

50. A system in accordance with claim 49 wherein said application server comprises a view component, a model component, and a controller component, said controller component in communication with said view component and said model component, said model component in communication with said centralized database.

51. A computer program embodied on a computer readable medium for managing business information by a first business entity, said program comprising a code segment that receives business information relating to at least one second business entity and then:
calculates business information based on business information previously received;
generates a plurality of reports based on business information received;
validates business information contained in the reports;
stores business information and the generated reports in a database;
updates said database by adding, editing, and revising business information;
tracks business information stored in said database; and
provides users with access to business information.

52. A computer program in accordance with claim 51 further comprising a code segment that generates a plurality of templates for receiving business information, said templates include at least one of an income statement, a balance sheet, a collateral metrics report, and a financial ratios report.

53. A computer program in accordance with claim 51 further comprising a code segment that calculates business information by:
linking together data fields included within at least one of the plurality of reports and assigning a formula to the linked data fields such that data entered into detailed data fields is inputted into the assigned formula and the resulting value is displayed in a calculation data field; and
linking together data fields included within the plurality of reports and assigning a formula to the linked data fields such that data entered into detailed data fields is inputted into the assigned formula and the resulting value is displayed in a calculation data field.

54. A computer program in accordance with claim 51 further comprising a code segment that validates business information by:
linking together data fields included within at least one of the plurality of reports and assigning a formula to the linked data fields to assure that the business information received through the client system is accurate and correct; and
linking together data fields included within the plurality of reports and assigning a formula to the linked data fields to assure that the business information received through the client system is accurate and correct.

55. A computer program in accordance with claim 51 further comprising a code segment that updates said database by:
adding newly received business information and a plurality of reports generated therefrom to said database;
editing existing business information and existing reports generated therefrom stored in said database with newly received business information such that edited business information and edited reports are stored in said database replacing existing business information and existing reports; and
revising existing business information and generating a plurality of revised reports therefrom such that revised business information and revised reports are stored in said database with existing business information and existing reports.

56. A computer program in accordance with claim 51 further comprising a code segment that tracks business information stored in said database by:
assigning a revision number to business information and each of the plurality of reports generated therefrom;
sequentially updating said revision number assigned to the business information and each of the plurality of reports generated therefrom when a user revises the business information and the reports generated therefrom; and
tracking said revision number assigned to the business information and each of the plurality of reports stored in said centralized database.

57. A computer program in accordance with claim 51 further comprising:
a code segment that accesses said database;
a code segment that searches said database in response to an inquiry;
a code segment that retrieves information from said database;
a code segment that causes retrieved information to be displayed on a client system; and
a code segment that transmits comments relating to a review of business information and the plurality of reports generated therefrom.

58. A computer program in accordance with claim 51 further comprising a code segment that monitors the security of the system by restricting access to authorized individuals.
